(19) United States
(12) Patent Application Publication
(10) Pub. No.: US 2026/0008031 A1
(43) Pub. Date: Jan. 8, 2026

(54) CATALYST FOR DECOMPOSING PERFLUOROCOMPOUNDS AND METHOD OF PREPARING SAME

(71) Applicants: HEESUNG CATALYSTS CORPORATION, Gyeonggi-do (KR); SAMSUNG ELECTRONICS CO., LTD., Gyeonggi-do (KR)

(72) Inventors: Jungje Park, Gyeonggi-do (KR); Taewoo Lee, Gyeonggi-do (KR); Hyunsik Han, Gyeonggi-do (KR); Jun Lee, Gyeonggi-do (KR); Jaeuk Han, Gyeonggi-do (KR); Jinwoo Song, Gyeonggi-do (KR); Iljeong Heo, Gyeonggi-do (KR); Daeok Kim, Gyeonggi-do (KR); Woosung Choi, Gyeonggi-do (KR); Seoungjun Lee, Gyeonggi-do (KR)

(21) Appl. No.: 19/256,362

(22) Filed: Jul. 1, 2025

(30) Foreign Application Priority Data
Jul. 5, 2024 (KR) 10-2024-0088636

(51) Int. Cl. B01J 21/04; B01J 21/06; B01J 23/06; B01J 23/30; B01J 35/40; B01J 35/57

(52) U.S. Cl. CPC B01J 21/04; B01J 21/066; B01J 23/06; B01J 23/30; B01J 35/40; B01J 35/57

(57) ABSTRACT

Described are a catalyst, a perforated pellet, a honeycomb-type catalyst body for decomposing perfluorocompounds (PFCs) and a method of preparing the same.

### CROSS REFERENCE TO RELATED APPLICATION

The present application claims priority to Korean Patent Application No. 10-2024-0088636, filed Jul. 5, 2024, the entire contents of which is incorporated herein for all purposes by this reference.

### BACKGROUND OF THE DISCLOSURE

### 1. Field of the Disclosure

The present disclosure relates to the decomposition of perfluorocompounds (PFCs) and, more specifically, to a catalyst for decomposing perfluorocompounds and a method of preparing the same.

### 2. Description of the Related Art

PFCs (CF₄, C₄F₈, CHF₃, CxHyFz) generated in a semiconductor process act as serious greenhouse gases when released into the atmosphere.

TABLE 1

| | | GWP for | GWP for |
|---|---|---|---|
| Greenhouse gas | Lifespan | a 20-year | a 100-year |
| (Chemical formula) | (years) | time horizon* | time horizon |
| Methane (CH₄) | 12.4 | 86 | 34 |
| Nitrous oxide (N₂O) | 121.0 | 268 | 298 |
| Carbon tetrafluoride | 50000 | 4950 | 7350 |
| (CF₄) | | | |

*GWP (Global Warming Potential): Radiative forcing that can absorb and trap greenhouse gases compared to carbon dioxide

A hydrolysis method using a catalyst has been used to treat PFCs contained in waste gases discharged from a semiconductor process. The hydrolysis method is known as a process in which the PFC decomposition reaction proceeds at a high temperature in a range of 700° C. to 900° C. using an alumina catalyst and water vapor. However, in this high-temperature decomposition reaction, the properties of a carrier of the alumina catalyst are converted and the specific surface area of the carrier is reduced, leading to a decrease in active points and finally to a decrease in durability.

### CF₄ Hydrolysis Reaction Mechanism

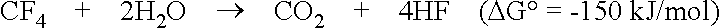

### SUMMARY OF THE DISCLOSURE

Therefore, there is a need to improve the durability of a catalyst for decomposing PFCs. In addition, there is a demand in the industry for a catalyst for decomposing PFCs to have an improved conversion rate and improved durability, compared to conventional catalysts for decomposing PFCs. Furthermore, a catalyst for decomposing PFCs with improved activity and durability, and at the same time with optimized shape, size, and strength is needed considering formulation in a PFC decomposition system. In addition, considering corrosion by hydrofluoric acid (HF aqueous solution), relatively low differential pressure, and heat storage performance, honeycomb-type catalyst articles are required other than conventional pelletized forms.

A solution to the problem of the present disclosure is to provide a catalyst for decomposing PFCs with high reaction activity and durability by combining aluminum oxide with zinc (Zn) as an active component for performance improvement and tungsten (W) and zirconium (Zr) as auxiliary components to prepare a Zr—W—Zn—Al catalyst.

Without limitation, the precursor of zinc (Zn) applied in the catalyst for decomposing PFCs may be any one selected from zinc nitrate (Zn(NO₃)₂), zincsulfatehydrate (ZnSO₄H₂O), and zincacetate ((CH₃CO₂)₂Zn). The precursors of tungsten (W) may be any one selected from ammonium metatungstate ((NH₄)₆H₂W₁₂O₄₀·3H₂O), ammonium paratungstate ((NH₄)₁₀H₂W₁₂O₄₂·4H₂O), sodium tungstate (Na₂WO₄·2H₂O), tungsten oxide (WO₃), and tungsten chloride (WCl₆), or mixtures thereof. Aluminum oxide may be any one selected from gamma alumina (γ—Al₂O₃), aluminum trihydroxide, boehmite, and pseudo-boehmite. On the other hand, the precursor of zirconium (Zr) may be zirconium nitrate (Zr(NO₃)₄), zirconium hydroxide (Zr(OH)₄), zirconium oxide (ZrO), or a mixture thereof.

In addition, the Zr—W—Zn—Al catalyst is provided as a catalyst for decomposing PFCs with a weight ratio of Al, Zn, W and Zr at 100:20 to 100:1 to 11:20 to 100.

Another solution to the problem is to provide a catalyst for decomposing PFCs, the catalyst being prepared using an impregnation method, a co-precipitation method, or a physical mixing method as a method of preparing the catalyst.

Yet another solution to the problem is to provide a method for preparing a molded body of a catalyst for decomposing PFCs.

The method includes mixing aluminum oxide with zinc (Zn) as an active component for performance improvement and tungsten (W) and zirconium (Zr) as auxiliary components and molding the mixture into one or more of the following shapes: particles, spheres, pellets, rings and honeycombs. Further, it also includes preparing the above mixture in the form of a slurry and coating it on a honeycomb carrier to provide a honeycomb-type catalyst article. When the catalyst is produced as a pellet type catalyst, it may preferably be produced as a perforated pellet having one or more perforations, more preferably as a four-perforated pellet. Non-limitingly, the pellet type may be a pellet type having round edges.

Yet another solution to the problem is to provide a method for decomposing PFCs, and the method includes introducing water vapor from the outside into the reactor to perform a hydrolysis reaction in a catalyst reactor filled with a molded body of a catalyst for decomposing PFCs.

A catalyst for decomposing PFCs according to the present disclosure has an effect of having durability against fluorine generated by decomposition of PFCs, as well as a synergistic effect of improving reaction activity.

Another effect is that the catalyst for decomposing PFCs of the present disclosure decomposes perfluorocompounds at a lower temperature than conventional catalysts for decomposing PFCs, making it easier to reduce operating costs and ensure the durability of a system during continuous operation, as well as making it possible to miniaturize the system due to the high reaction activity of the catalyst.

The four-perforated pellets with rounded edges of the present invention have optimum performance in terms of system differential pressure, contact area with the reactant gas and abrasion losses when filling the reactor.

The honeycomb-type catalyst article of the present invention has a higher HF endurance performance and a relatively lower differential pressure than the pellet-type catalyst molded body, and has a heat storage performance equivalent to that of conventional heat storage materials, so when the honeycomb-type catalyst of the present invention is applied to the location of the heat storage material, the effect of increasing the operating time by improving the performance can be expected.

### BRIEF DESCRIPTION OF THE DRAWINGS

FIG. 1 illustrates a performance evaluation chart of a catalyst for decomposing PFCs, the catalyst being of alumina combined with zinc (Zn) as an active component for performance improvement and tungsten (W) and zirconium (Zr) as auxiliary components, as obtained in a fresh state of the catalyst and aged state of the catalyst after accelerated evaluation, respectively, when zinc (Zn) is added to alumina as an active component for performance improvement, improvement in the performance of the catalyst is confirmed, and when tungsten (W) and zirconium (Zr) are added auxiliary components, improvement in the durability of the catalyst compared to tungsten alone as an auxiliary component is confirmed. It is also found that even if the precursors of zirconium (Zr) are zirconium nitrate (Zr(NO₃)₄), zirconium hydroxide (Zr(OH)₄) and zirconium oxide (ZrO), there is no significant change in durability performance;

FIG. 2A shows photographs of unperforated, 1-perforated, and 4-perforated pellets.

FIG. 2B shows a plot of differential pressure as a function of linear velocity for different pellet shapes.

FIG. 3A is a plot of differential pressure as a function of linear velocity for a plain four-perforated pellet and a curved-edge four-perforated pellet.

FIG. 3B is a plot of abrasion loss.

FIG. 4 shows the performance evaluation of PFC degradation catalysts with four-perforated pellets and PFC degradation catalysts coated on honeycomb.

### DESCRIPTION OF THE PREFERRED EMBODIMENTS

Perfluorocompounds may include carbon-containing PFCs, nitrogen-containing PFCs, and sulfur-containing PFCs which all contain two or more fluorine (F). Carbon-containing PFCs may include cyclic aliphatic and aromatic perfluorocarbons, as well as saturated and unsaturated aliphatic components such as CF₄, CHF₃, CH₂F₂, C₂F₄, C₂F₆, C₃F₆, C₃F₈, CF₈, and C₄F₁₀. Nitrogen-containing PFCs may typically include NF₃, and sulfur-containing PFCs may include SF₄ and SF₆. Furthermore, PFCs may even include compounds that can be decomposed by a catalyst to form gaseous products such as HF.

An acid gas referred to herein is a gas that becomes acidic when in contact with water, and non-limiting examples thereof include halogen, hydrogen halide, nitrogen oxides (NOx), sulfur oxides (SOx), acetic acid, sublimated mercury, hydrogen sulfide, and carbon dioxide. The acid gas not only causes corrosion but can also reduce the activity of the catalyst.

A hydrolysis reaction that occurs between PFCs and moisture is an endothermic reaction. Accordingly, the hydrolysis reaction can induce a spontaneous reaction, which means the higher the temperature, the easier it is to decompose PFCs. Thus, PFC decomposition progresses faster. However, the thermal stability of the catalyst decreases due to high temperature. In other words, the operating conditions at a temperature in a range of 700° C. to 900° C. are high-temperature conditions for the catalyst to maintain activity for a long time without physical or chemical changes, so securing the durability of the catalyst is the biggest problem. In particular, there is a need to develop a catalyst that continues to be durable in a reaction atmosphere at a temperature in a range of 700° C. to 900° C. where both HF and water vapor generated as by-products exist.

The present disclosure provides a catalyst for decomposing PFCs that has excellent decomposition activity and durability for PFCs used in a semiconductor manufacturing process and can maintain catalytic activity for a long time. The present disclosure relates to a catalyst for decomposing PFCs that has an excellent performance in decomposing perfluorocompounds even at low temperatures, making it easy to reduce operating costs and ensure system durability during continuous operation.

Various embodiments are presented to achieve the objectives of the present disclosure.

A first embodiment of the present disclosure relates to a catalyst for decomposing PFCs. In the catalyst, zinc as an active component for performance improvement and tungsten (W) and zirconium (Zr) as auxiliary components are added to an alumina precursor selected from at least one of gamma alumina, aluminum trihydroxide, boehmite, and pseudo-boehmite. The catalyst has a weight ratio of Al, Zn, W, and Zr at 100:20 to 100:1 to 11:20 to 100.

A second embodiment of the present disclosure presents a method in which an aqueous solution of a zinc (Zn) precursor, tungsten (W) and zirconium (Zr) precursors dissolved in distilled water is mixed with at least one alumina precursor selected from gamma alumina, aluminum trihydroxide, boehmite, and pseudo-boehmite, followed by drying and mixing to prepare a Zn—W—Al catalyst powder. The Zn—W—Zr—Al catalyst powder has a weight ratio of Al, Zn, W, Zr at 100:20 to 100:1 to 11:20 to 100.

In particular, four-pore pellets are made using the Zn—W—Zr—Al catalyst powder, or a honeycomb-type catalyst body is provided by coating the Zn—W—Zr—Al catalyst powder on a honeycomb carrier.

A third embodiment of the present disclosure provides a method for treating perfluorocompounds, including decomposing PFCs in a perfluorocompound-containing gas using the catalyst for decomposing PFCs of the first embodiment.

A fourth embodiment of the present disclosure relates to a semiconductor manufacturing process including decomposing a perfluorinated compound in a perfluorocompound-containing gas using the catalyst for decomposing PFCs of the first embodiment.

The precursors of zinc (Zn) in the catalyst for decomposing PFCs may be any one selected from zincnitrate (Zn(NO₃)₂), zincsulfatehydrate (ZnSO₄H₂O), and zincacetate ((CH₃CO₂)₂Zn). The precursors of tungsten (W) may be any one selected from ammonium metatungstate ((NH₄)₆H₂W₁₂O₄₀·3H₂O), ammonium paratungstate ((NH₄)₁₀H₂W₁₂O₄₂·4H₂O), sodium tungstate (Na₂WO₄·2H₂O), tungsten oxide (WO₃), and tungsten chloride (WCl₆), or mixtures thereof, and the precursor of zirconium (Zr) can be zirconium nitrate (Zr(NO₃)₄), zirconium hydroxide (Zr(OH)₄), zirconium oxide (ZrO) or a mixture thereof. Alumina may be any one selected from alpha alumina, gamma alumina (γ—-Al₂O₃), aluminum trihydroxide, boehmite, and pseudo-boehmite.

One example of a catalyst for decomposing PFCs is to prepare a catalyst for decomposition by combining alumina, zinc, tungsten, and zirconium to the weight ratio of Al, Zn, W, and Zr at 100:20 to 100:1 to 11:20 to 100 after impregnating gamma alumina with zinc, tungsten, zirconium precursors and sequentially or simultaneously. The method for preparing the catalyst for decomposing PFCs is any one selected from an impregnation method, a co-precipitation method, and a physical mixing method.

In the catalyst for decomposing PFCs, γ-alumina is preferred as a support or carrier working with an active component for performance improvement and auxiliary components. In addition, the PFC decomposition catalyst according to the present invention can suppress the transition of γ-alumina to the α-phase, and there is a synergistic effect of maintaining a high PFC decomposition ability of the catalyst for a long time.

When zinc (Zn) is added as an active metal for performance improvement, desirable results can be given in terms of improvement in conversion rate during the PFC catalytic decomposition reaction. Additionally, durability is greatly improved when tungsten (W) and zirconium (Zr) are impregnated as a co-catalyst or auxiliary components.

The catalyst for decomposing PFCs prepared is dried at a temperature in a range of 150° C. or higher and can be fired in an air atmosphere at a temperature in a range of 600° C. to 900° C., and ultimately formed into a catalyst powder. Using the catalyst powder, the final shape of the catalyst may be a granular shape such as a sphere, pellet, preferably 4-perforated pellet, or ring, or may be molded into a honeycomb.

Specifically, the pellet type is selected taking into account the following conditions. First, the system differential pressure is considered. When filling the catalyst in pellet form, differential pressure is generated in the PFC degradation reactor, high differential pressure affects the overall system operation, and reaching to the system limit differential pressure, the system is forced to shut down. Therefore, a pellet shape that can maintain a low differential pressure within the reactor is preferred. Secondly, the pellet exposure area is considered. Ultimately, pellets with a high exposure area are desirable because a higher exposure area increases the contact area with the reactant gas, which is associated with better PFC degradation performance. Finally, the abrasion loss of the pellet in the reactor is taken into account. Pellets with high abrasion losses are prone to cracking during catalyst loading and operation, and pellets with low abrasion losses are preferred, as cracked catalysts result in powder and chips, which can cause performance degradation due to reduced effective catalyst content and increased differential pressure.

On the other hand, the catalyst powder can also be prepared as a slurry suspension and then coated on a honeycomb carrier to provide a honeycomb-type catalyst body.

The catalyst for decomposing PFCs exhibits excellent decomposition effect and durability in decomposing and removing perfluorocompounds containing halogen acid gases. Therefore, the catalyst can be used in processes containing halogen acid gases, especially to decompose perfluorocompounds used in the semiconductor manufacturing industry.

The temperature during the PFC catalytic decomposition reaction is in a range of 600° C. to 800° C., preferably 650° C. to 750° C.

To perform a hydrolysis reaction in the catalytic reactor, water may be introduced into the reactor from the outside. Water may be supplied through a separately provided source outside the reactor, and may be supplied in the form of water vapor before flowing into the reactor. Preferably, pure water is used as the water supplied into the reactor, and the supply amount can be adjusted considering the hydrolysis reaction rate.

Hereinafter, the catalyst will be prepared in detail and the effects of the prepared catalyst will be described.

### Example 1

### Preparation of Zn—Al Catalyst (Al:Zn=100:62 Weight Ratio)

A solution of 107 g of zincnitrate in distilled water was mixed with 71 g of aluminum oxide, dried at a temperature of 150° C. for 3 hours, and fired at a temperature of 750° C. for 10 hours.

### Example 2

### Preparation of Zr—W—Zn—Al Catalyst (Al:Zn:W:Zr=100:31:6:32 Weight Ratio)

A solution of 38 g of zirconium nitrate (Zr(NO₃)₄), 3.2 g of ammoniummetatungstate dissolved in distilled water was mixed with 82 g of the catalyst prepared in Example 1, dried at a temperature of 150° C. for 3 hours, and fired at a temperature of 750° C. for 10 hours. Zirconium hydroxide (Zr(OH)₄) or zirconium oxide (ZrO) may be used instead of zirconium nitrate as the zirconium precursor. The content of each component of the Zr—W—Zn—Al catalyst according to the present embodiment can be adjusted as Al:Zn:W:Zr=100:20 to 100:1 to 11:20 to 100 in a weight ratio.

### Example 3

The Zr—W—Zn—Al catalyst powder prepared in Example 2 was used to prepare unperforated, 1-perforated, 4-perforated, 7-perforated and 10-perforated pellets with the properties listed in Table 2.

TABLE 2

| | diameter | length | exposed area | |
|---|---|---|---|---|
| | (mm) | (mm) | (m²)/1L | hole Ø(mm) |
| unperforated | 5 | 4.7 | 0.94 | — |
| 1-perforated | 8 | 5 | 0.76 | 2.9 |
| 4-perforated | 15.4 | 5.5 | 0.59 | 2.0 |
| 7-perforated | 16 | 19 | 0.48 | 2.0 |
| 10-perforated | 20 | 12 | 0.43 | 2.0 |

### Example 4

The edges of the four-perforated pellets prepared in Example 3 were processed to produce curved-edge four-perforated pellets.

### Example 5

The catalyst powder prepared in Example 2 was dispersed in water to make a slurry suspension with a particle size of 5-20 um by dispersing the solids to be 10-50%, and then coated to a cylindrical monolithic carrier made of alumina at a dry gain of 100-500 g/L, dried at 80°-150° C., and fired at 400°-800° C. to obtain a honeycomb-type catalyst body.

### Comparative Example 1

Preparation of W—Zn—Al catalyst (Al:Zn:W=100:62:11 weight ratio)

A W—Zn—Al catalyst was prepared by performing the same method as in Example 2 above, except that zirconium nitrate was not applied and only ammoniummetatungstate was dissolved in distilled water.

### Experiment Example 1

To compare the removal efficiency of perfluorocompounds (CF₄) by the catalysts prepared in the Examples and Comparative Example, the performance was evaluated under the following experimental conditions.

18 ml of each of the catalysts prepared in Examples and Comparative Example were taken and filled in a 1-inch Inconel reaction tube. The reaction temperature was adjusted to 700° C. using an external heater. 2000 ppm of tetrafluoromethane (CF₄) was decomposed by each of the catalyst samples at a space velocity of 17,000 h⁻¹ and in an atmosphere of 6% oxygen (O₂), and 10% water (H₂O). The tetrafluoromethane removal efficiency was calculated using Equation 1 below, and the reactant was analyzed using FT-IR.

$${CF}_{4} removal efficiency ( \% ) = ( {CF}_{4} concentration at reactor inlet - {CF}_{4} concentration at reactor outlet ) / {CF}_{4} concentration at reactor inlet ⋆ 100 \qquad 〈 Equation 1 〉$$

### Experiment Example 2

Accelerated evaluation (in an aged state of the catalysts) was evaluated under the same experimental conditions after treating the prepared catalysts in a hydrofluoric acid (HF) solution for 3 hours followed by drying and re-firing.

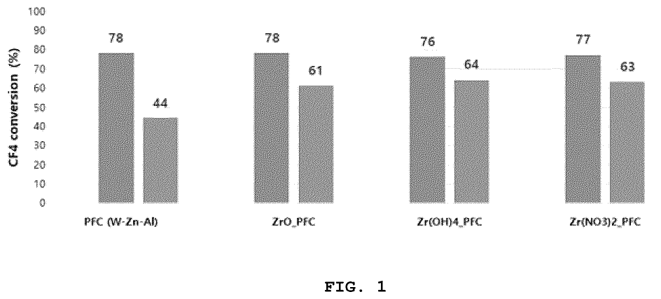

FIG. 1 illustrates a performance evaluation chart of a catalyst for decomposing PFCs, the catalyst serving as a carrier of alumina combined with zinc (Zn) as an active component for performance improvement and tungsten (W), zirconium (Zr) as auxiliary components, as obtained in a fresh state of the catalyst and aged state of the catalyst after accelerated evaluation, respectively. The present inventors found that the combination of tungsten (W) and zirconium (Zr) as auxiliary a components improves the durability performance from 44% to 61-63% as percentage of conversion, compared to the catalyst with tungsten (W) alone as auxiliary component. Furthermore, the change in durability performance is not significant even if the precursor of zirconium (Zr) is zirconium nitrate (Zr(NO₃)₄), zirconium hydroxide (Zr(OH)₄) or zirconium oxide (ZrO).

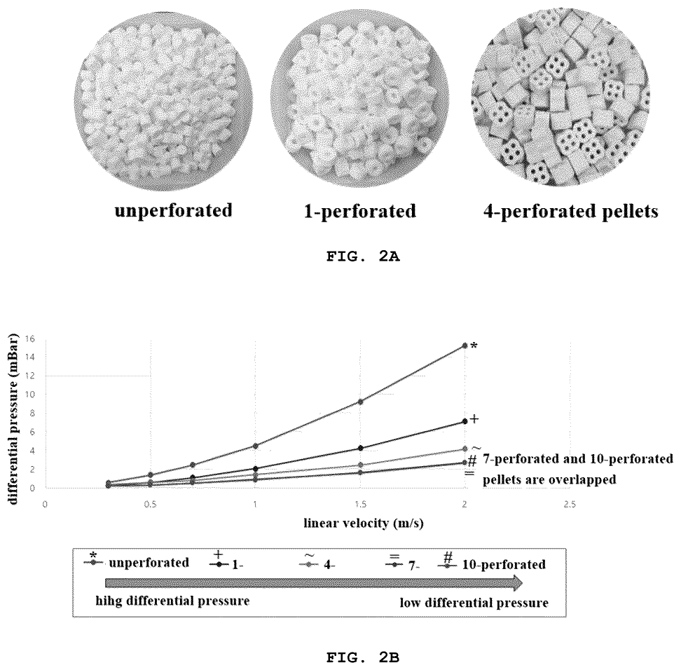

FIG. 2A shows photographs of unperforated, one-perforated, and four-perforated pellets, and FIG. 2B is a plot evaluating the differential pressure as a function of linear velocity for different pellet shapes. While it is desirable that pellets with more pores have a lower differential pressure in the reactor, pellets with more pores have a larger volume per piece, which reduces the number of pellets that can be placed in a reactor of the same volume. Therefore, pellets with more pores have the disadvantage of reducing the overall exposure area in a reactor of the same volume, and therefore, a catalyst of four-perforated pellets is proposed in the present invention in which both differential pressure and exposure area (performance) are optimized.

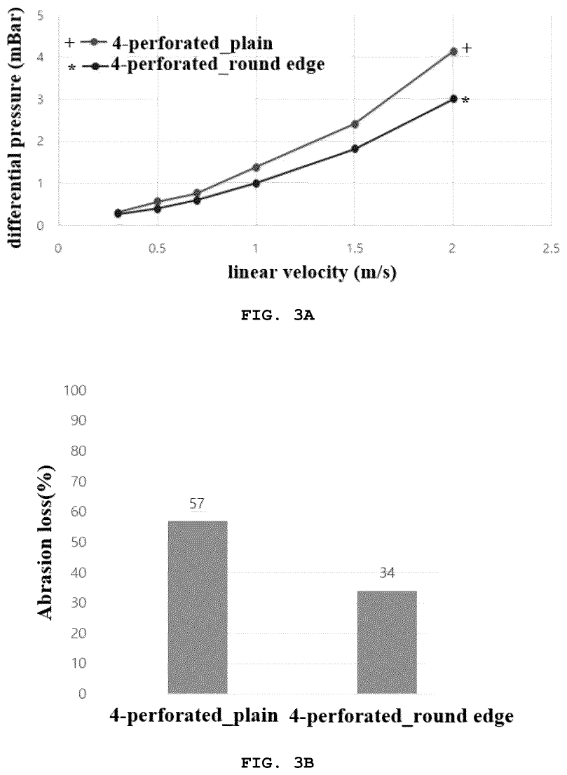

FIG. 3A shows the evaluation of differential pressure as a function of linear velocity for plain four-pore pellets and round edge four-pore pellets, and FIG. 3B shows the evaluation of abrasion loss. It was found that the introduction of round edges to the plain pellets is beneficial from a differential pressure and abrasion loss perspective.

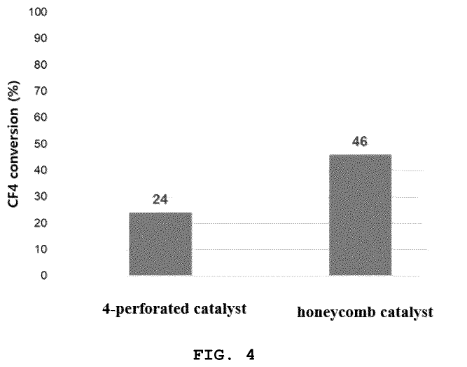

FIG. 4 illustrates a chart evaluating the performance evaluation PFC degradation catalysts in the form of perforated pellet and PFC degradation catalysts coated on honeycomb, showing the honeycomb-type catalyst has about a 2-fold improvement in CF₄ cracking performance compared to the four-pore type catalyst.

Referring to the described examples and experiment examples, the aluminum oxide catalyst for decomposing PFCs and a method of preparing the same according to the examples of the present disclosure can improve decomposition efficiency and durability for PFCs, and although the present disclosure has been described with reference to preferred examples, it will be understood that those skilled in the art can make various modifications and changes to the present disclosure without departing from the spirit and scope of the present disclosure disclosed in the claims below.

What is claimed is:

1. A catalyst composition for decomposing PFCs comprising alumina selected from at least one of gamma alumina, aluminum trihydroxide, boehmite, and pseudo-boehmite, the alumina being added with zinc as an active component for performance improvement and tungsten (W) and zirconium (Zr) as auxiliary components, in which a weight ratio of Al, Zn, W, and Zr is at 100:20 to 100:1 to 11:20 to 100.

2. A catalyst article for decomposing PFCs wherein the catalyst composition of claim 1 is coated on a honeycomb carrier.

3. A catalyst for decomposing PFCs wherein the catalyst composition of claim 1 is formed into a four-perforated pellet.

4. The catalyst of claim 3, wherein the four-perforated pellet has round edges.
